(19) United States
(12) Patent Application Publication
(10) Pub. No.: US 2026/0235532 A1
(43) Pub. Date: Aug. 13, 2026

(54) INSPECTION APPARATUS AND METHOD FOR INSPECTING SEMICONDUCTOR DEVICE

(71) Applicants: Kabushiki Kaisha Toshiba, Tokyo (JP); Toshiba Electronic Devices & Storage Corporation, Tokyo (JP)

(72) Inventor: Ikuo MOTONAGA, Kitakyushu Fukuoka (JP)

(21) Appl. No.: 19/278,428

(22) Filed: Jul. 23, 2025

(30) Foreign Application Priority Data
Feb. 13, 2025 (JP) 2025-021576

(51) Int. Cl. G01N 21/95; G01N 21/88

(52) U.S. Cl. CPC G01N 21/9503; G01N 21/8851; G01N 2021/8887

(57) ABSTRACT

According to one embodiment, an inspection apparatus for inspecting a semiconductor device contained in a rectangular pocket included in carrier tape includes an acquiring unit, a detecting unit, a generating unit, and an inspecting unit. The acquiring unit is configured to acquire an inspection image obtained by imaging the semiconductor device with an imaging device. The detecting unit is configured to determine a contour of the pocket by performing edge detection on the inspection image. The generating unit is configured to generate a mask corresponding to a region extending inward from the determined contour by a predetermined width. The inspecting unit is configured to inspect the semiconductor device with the mask set in the inspection image.

### CROSS-REFERENCE TO RELATED APPLICATIONS

This application is based upon and claims the benefit of priority from prior Japanese Patent Application No. 2025-021576, filed Feb. 13, 2025, the entire contents of which are incorporated herein by reference.

### FIELD

Embodiments described herein relate generally to an inspection apparatus and a method for inspecting a semiconductor device.

### BACKGROUND

Semiconductor devices are shipped as products in a state of being contained in pockets of carrier tape. In the case of performing an automatic inspection of a semiconductor device, the semiconductor device is imaged with a camera installed immediately above the semiconductor device, and a pitch of (an interval between) leads and a deviation in length of the leads are measured.

In such an inspection, there is a case where an image of a tip of a lead is reflected on a side surface of the pocket. In particular, in the case where the tip of the lead is close to the side surface of the pocket, the tip of the lead and its reflection appear to be joined together, thus forming a virtual image in which the lead appears to have a greater length than it actually is. In such a case, erroneous detection of the leads occurs, making it difficult to accurately perform an automatic inspection.

### BRIEF DESCRIPTION OF THE DRAWINGS

FIG. 1 is a plan view of a semiconductor device according to a first embodiment.

FIG. 2 is a cross-sectional view of the semiconductor device taken along line A-A′ shown in FIG. 1.

FIG. 3 is a block diagram of an inspection apparatus according to the first embodiment.

FIG. 4 is a block diagram showing an example of a hardware configuration of the inspection apparatus.

FIG. 5 is a diagram illustrating an example of the image obtained by imaging the semiconductor device with a camera.

FIG. 6 is a diagram illustrating another example of an image obtained by imaging the semiconductor device with a camera.

FIG. 7 is a flowchart illustrating an inspection operation of the inspection apparatus according to the first embodiment.

FIG. 8 is a diagram illustrating an inspection step performed by the inspection apparatus.

FIG. 9 is a diagram illustrating an inspection step performed by the inspection apparatus.

FIG. 10 is a diagram illustrating an inspection step performed by the inspection apparatus.

FIG. 11 is a diagram illustrating an inspection step performed by an inspection apparatus according to a modification.

FIG. 12 is a flowchart illustrating an inspection operation of an inspection apparatus according to a second embodiment.

FIG. 13 is a diagram illustrating an inspection step performed by the inspection apparatus.

FIG. 14 is a diagram illustrating an inspection step performed by the inspection apparatus.

FIG. 15 is a diagram illustrating an inspection step performed by an inspection apparatus according to a modification.

### DETAILED DESCRIPTION

In general, according to one embodiment, there is provided an inspection apparatus for inspecting a semiconductor device, the semiconductor device being contained in a rectangular pocket included in carrier tape, the inspection apparatus comprising: an acquiring unit configured to acquire an inspection image obtained by imaging the semiconductor device with an imaging device; a detecting unit configured to determine a contour of the pocket by performing edge detection on the inspection image; a generating unit configured to generate a mask corresponding to a region extending inward from the determined contour by a predetermined width; and an inspecting unit configured to inspect the semiconductor device with the mask set in the inspection image.

Hereinafter, embodiments will be described with reference to the accompanying drawings. The embodiments to be described below are presented merely as examples of an apparatus and a method for embodying the technical idea of the present invention, and do not intend to specify the technical idea of the present invention by the shape, structure, arrangement, etc. of the structural components. Each functional block can be realized as either hardware or software, or a combination of them. It is not essential that the functional blocks in each embodiment be distinguished as in the following example. For example, some of the functions may be executed by functional blocks different from those to be described as an example. Furthermore, the functional blocks to be described as an example may be divided into smaller functional subblocks. Note that, in the description that follows, elements having an identical function and configuration will be assigned an identical symbol, and an overlapping description will be omitted.

### <1> First Embodiment

### <1-1> Configuration of Semiconductor Device 1

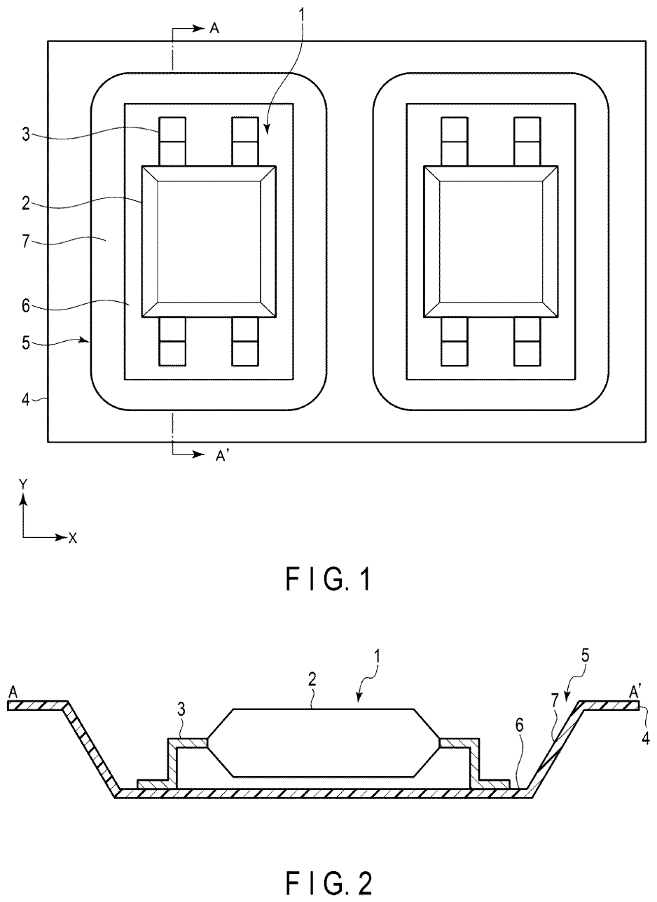

FIG. 1 is a plan view of a semiconductor device 1 according to a first embodiment. FIG. 2 is a cross-sectional view of the semiconductor device 1 taken along line A-A′ shown in FIG. 1. In FIG. 1, an X direction is a direction along a given side of the semiconductor device 1, and a Y direction is a direction orthogonal to the X direction. FIG. 1 shows, as an example, two semiconductor devices 1.

The semiconductor device 1 includes a resin part 2 and a plurality of leads 3. FIG. 1 shows, as an example, a configuration in which each semiconductor device 1 includes four leads 3. The number of leads 3 may be arbitrarily set.

The resin part 2 is in the shape of, for example, a rectangle. The resin part 2 includes a semiconductor element and a resin member configured to seal the semiconductor element.

Two leads 3, for example, are connected to one of two side portions of the resin part 2 in the Y direction, and two leads 3, for example, are connected to the other side portion of the resin part 2 in the Y direction. The plurality of leads 3 are electrically connected to the semiconductor element in the resin part 2. Each semiconductor device 1 may include a plurality of leads 3 in each of four side portions. Each lead 3 extends in a single direction, and has a bent cross-sectional shape (approximately a Z-shape).

The plurality of semiconductor devices 1 are held in carrier tape 4 extending in the X direction. Examples of materials that may be used as the carrier tape 4 include a resin containing carbon black. The material of the carrier tape 4 may be a transparent resin.

The carrier tape 4 includes a plurality of pockets 5 aligned at equal intervals in the X direction. Each pocket 5 has a contour that is approximately in the shape of a rectangle. Herein, the term “rectangle” includes a rectangle with rounded corners. The pocket 5 is configured of a rectangular bottom surface 6 and four side surfaces 7. The four side surfaces 7 are tilted surfaces that are inclined relative to a vertical direction. That is, the pocket 5 has a tapered shape. The pocket 5 is configured in such a manner that its area increases from the bottom surface 6 toward a top. The area of the bottom surface 6 of the pocket 5 is set to be slightly larger than an outer shape of the semiconductor device 1. The semiconductor device 1 is placed on the bottom surface 6 of the pocket 5.

An orientation in which the semiconductor device 1 is arranged in the pocket 5 may be arbitrarily set. The carrier tape 4 and the pocket 5 may be configured in such a manner that the lead 3 faces the X direction.

In the state shown in FIGS. 1 and 2, the semiconductor device 1 is subjected to an appearance inspection by an inspection apparatus 10, to be described below. Ultimately, protective tape (not illustrated) is adhered to a top of the carrier tape 4, allowing the semiconductor device 1 to be sealed inside the pocket 5.

### <1-2> Configuration of Inspection Apparatus 10

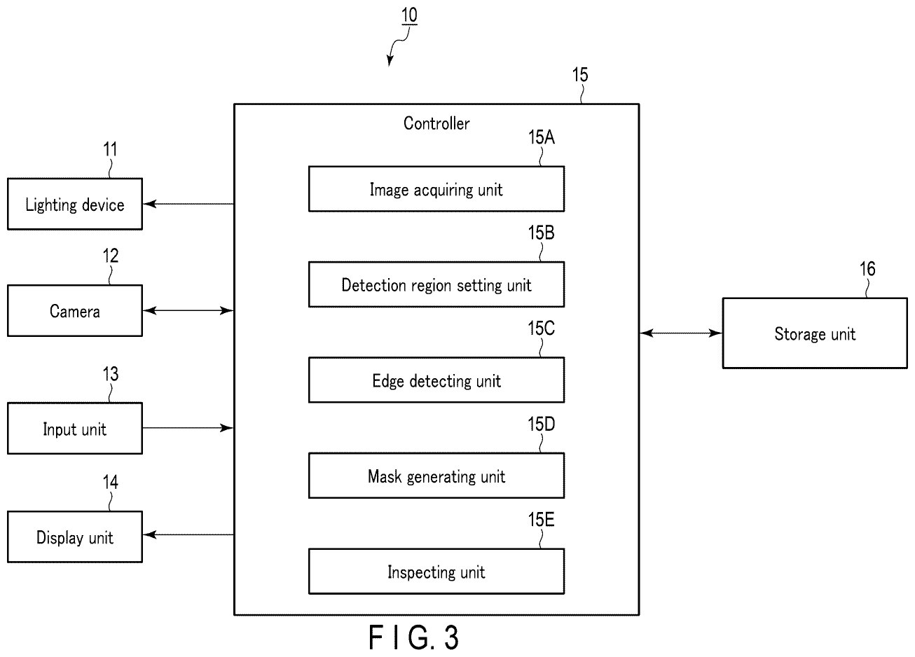

FIG. 3 is a block diagram of the inspection apparatus 10 according to the first embodiment. The inspection apparatus 10 is an apparatus configured to inspect a semiconductor device 1 contained in the carrier tape 4. Specifically, the inspection apparatus 10 measures dimensions of a plurality of leads included in the semiconductor device 1 and an interval between the leads, and determines a defective product based on results of the measurement. The inspection apparatus 10 includes a lighting device 11, an imaging device (camera) 12, an input unit 13, a display unit 14, a controller 15, and a storage unit 16.

The lighting device 11 irradiates a semiconductor device 1 to be inspected with light. The lighting device 11 is configured to be able to light up the semiconductor device 1 from a plurality of angles. For example, the lighting device 11 is configured to light up the semiconductor device 1 from directly above, and to light up the semiconductor device 1 from an oblique angle.

The camera 12 is arranged directly above the semiconductor device 1 to be inspected. The camera 12 images the semiconductor device 1 contained in a pocket 5 of the carrier tape 4. Also, the camera 12 continuously and sequentially images the plurality of semiconductor devices 1 contained in the carrier tape 4 and being conveyed.

The input unit 13 is equipped with a function of allowing a user to input information. The input unit 13 includes a keyboard, a mouse, etc.

The display unit 14 displays information generated by the controller 15. The display unit 14 includes a display device, etc.

The storage unit 16 stores various types of data necessary for operation of the controller 15. The storage unit 16 includes a nonvolatile memory and a volatile memory. The storage unit 16 is configured to include a program storage unit 21 and a data storage unit 22, to be described below.

The controller 15 controls operations of the entire inspection apparatus 10 in an integrated manner. The controller 15 includes an image acquiring unit 15A, a detection region setting unit 15B, an edge detecting unit 15C, a mask generating unit 15D, and an inspecting unit 15E. The image acquiring unit 15A is also referred to as an “acquiring unit”. The detection region setting unit 15B is also referred to as a “setting unit”. The edge detecting unit 15C is also referred to as a “detecting unit”. The mask generating unit 15D is also referred to as a “generating unit”.

The image acquiring unit 15A acquires an image (referred to as an “inspection image”) captured by the camera 12.

The detection region setting unit 15B sets a detection region 30 in the inspection image. The detection region 30 is set to have a larger area than the contour of the pocket 5.

The edge detecting unit 15C performs an edge detection process in a direction orthogonal to each of four sides of the detection region 30. The edge detecting unit 15C determines the contour of the pocket 5.

The mask generating unit 15D generates a mask 32 using the contour of the pocket 5. The mask 32 is image data that masks a periphery of the semiconductor device 1 to be inspected in the inspection image.

The inspecting unit 15E performs an appearance inspection of the semiconductor device 1 with the mask 32 set in the inspection image. The appearance inspection includes measurement and inspection of a plurality of leads 3.

### Hardware Configuration of Inspection Apparatus 10

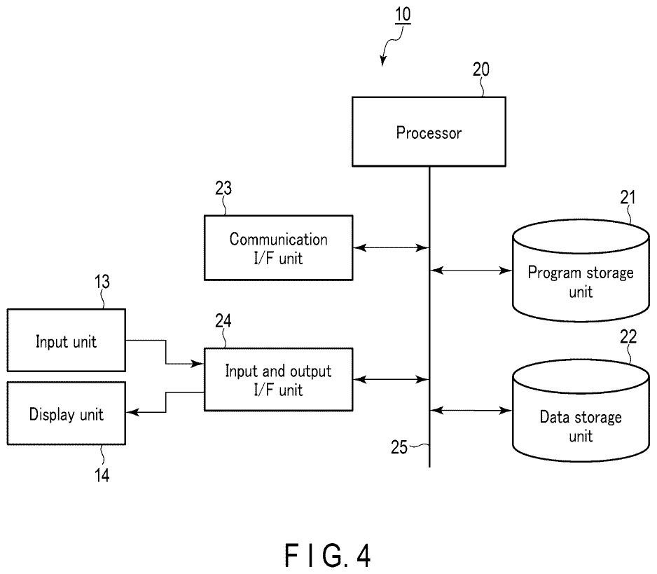

FIG. 4 is a block diagram showing an example of a hardware configuration of the inspection apparatus 10.

The inspection apparatus 10 can be configured of a computer. The inspection apparatus 10 includes a processor 20, a data storage unit 22, a program storage unit 21, a communication interface unit (communication I/F unit) 23, an input and output interface unit (input and output I/F unit) 24, an input unit 13, and a display unit 14. The data storage unit 22, the program storage unit 21, the communication interface unit 23, and the input and output interface unit 24 are connected to the processor 20 via the bus 25.

The processor 20 is configured of a central processing unit (CPU), a microprocessing unit (MPU), or the like. The processor 20 executes operations of the above-described controller 15.

The program storage unit 21 includes, for example, a nonvolatile memory into and from which data can be written and read at any time, such as a hard disk drive (HDD), a solid-state drive (SSD), or the like, and a nonvolatile memory such as a read-only memory (ROM). The program storage unit 21 stores programs necessary for the processor 20 to execute various processes according to the present embodiment. That is, the image acquiring unit 15A, the detection region setting unit 15B, the edge detecting unit 15C, the mask generating unit 15D, and the inspecting unit 15E are realized through execution of the programs stored in the program storage unit 21 by the processor 20.

The data storage unit 22 includes, for example, a nonvolatile memory such as an HDD, an SSD, or the like, and a volatile memory such as a random-access memory (RAM). The data storage unit 22 is used as a working area by the processor 20. The data storage unit 22 temporarily stores various data acquired and created in the course of various processes executed by the processor 20.

The communication interface unit 23 includes a wired communication module and/or a wireless communication module. The wireless communication module includes a wireless local area network (LAN). The communication interface unit 23 allows interface processing compliant with a predetermined communication standard to be performed with an external device. The communication interface unit 23 is capable of transmitting and receiving information to and from an external device.

The input unit 13 and the display unit 14 are connected to the input and output interface unit 24. The input and output interface unit 24 allows interface processing compliant with a predetermined communication standard to be executed between the input unit 13 and the display unit 14.

Also, the input and output interface unit 24 or the communication interface unit 23 receives image data from the camera 12.

### <1-3> Operations

Operations of the inspection apparatus 10 with the above-described configuration will be described. The inspection apparatus 10 performs an inspection using an inspection image obtained by imaging the semiconductor device 1 with the camera 12.

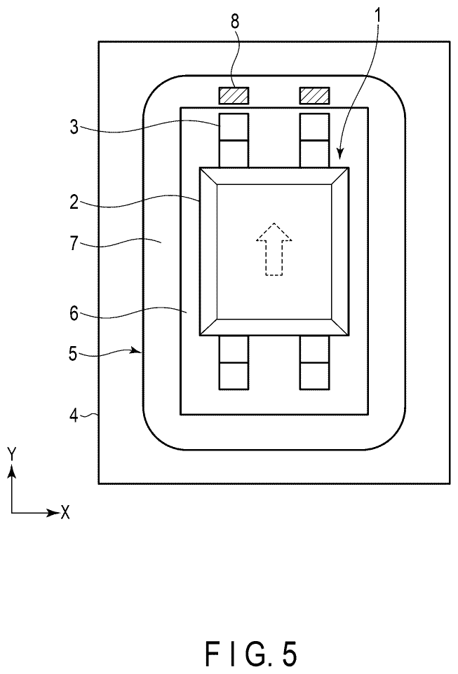

First, reflections of tips of the leads will be described. FIG. 5 is a diagram showing an example of an image obtained by imaging the semiconductor device 1 with the camera 12. In FIG. 5, the semiconductor device 1 is arranged at a position deviated from the center of the pocket 5 to the upper side as viewed in the drawing. The dashed arrow in FIG. 5 shows how the position of the semiconductor device 1 is deviated. In this case, one of the side surfaces 7 of the pocket 5 is irradiated with light reflected by the leads 3, and reflections 8 of the leads 3 appear on the side surface 7 of the pocket 5. The reflections 8 have substantially the same brightness as the leads 3. If an inspection is performed using the image of FIG. 5, the tips of the leads and the reflections are integrally recognized and erroneously detected as longer leads. Such an erroneous detection may prevent an appearance inspection of the semiconductor device 1 from being performed accurately.

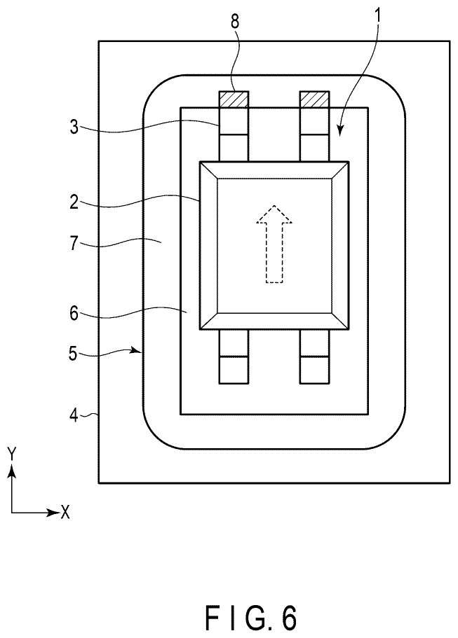

FIG. 6 is a diagram showing another example of an image obtained by imaging the semiconductor device 1 with the camera 12. In FIG. 6, the semiconductor device 1 is arranged at a position further deviated to the upper side as viewed in the drawing, compared to the structure shown in FIG. 5. The dashed arrow in FIG. 6 shows how the position of the semiconductor device 1 is deviated. In this case, too, reflections 8 of the leads 3 similarly appear on one of the side surfaces 7 of the pocket 5, thus causing an erroneous detection. Such an erroneous detection may prevent an appearance inspection of the semiconductor device 1 from being performed accurately.

In the present embodiment, even if reflections 8 of the leads 3 have appeared on one of the side surfaces 7 of the pocket 5, the inspection apparatus 10 is configured to be able to more accurately perform an appearance inspection of the semiconductor device 1.

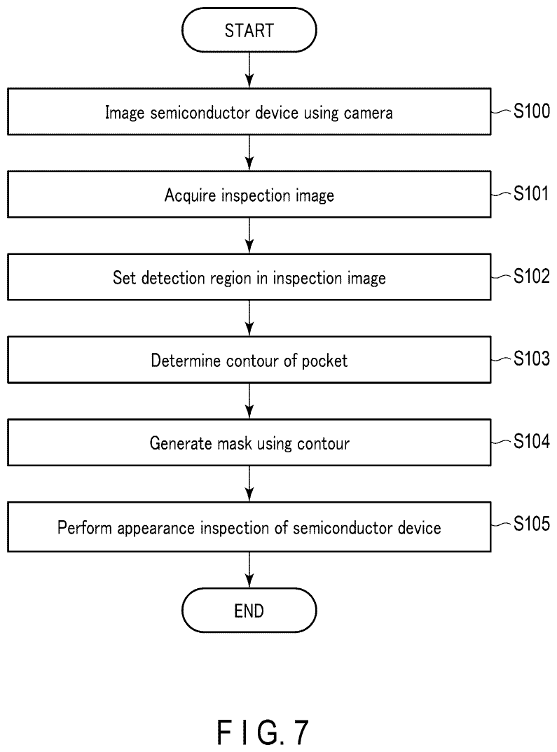

Hereinafter, details of an inspection operation according to the present embodiment will be described. FIG. 7 is a flowchart illustrating an inspection operation of the inspection apparatus 10.

In an inspection of semiconductor devices 1, the carrier tape 4 is conveyed in a single direction. A plurality of semiconductor devices 1 contained in the carrier tape 4 are sequentially conveyed to a position directly below the camera 12.

The inspection apparatus 10 images, using the camera 12, a semiconductor device 1 to be inspected (step S100). At the time of imaging, the inspection apparatus 10 irradiates the semiconductor device 1 with light using the lighting device 11. An inspection image is captured for each semiconductor device 1 to be inspected. The inspection image is captured to cover the entire pocket 5 shown in FIG. 1.

Subsequently, the image acquiring unit 15A acquires an inspection image captured at step S100 (step S101). The inspection image acquired at step S101 is stored in the storage unit 16.

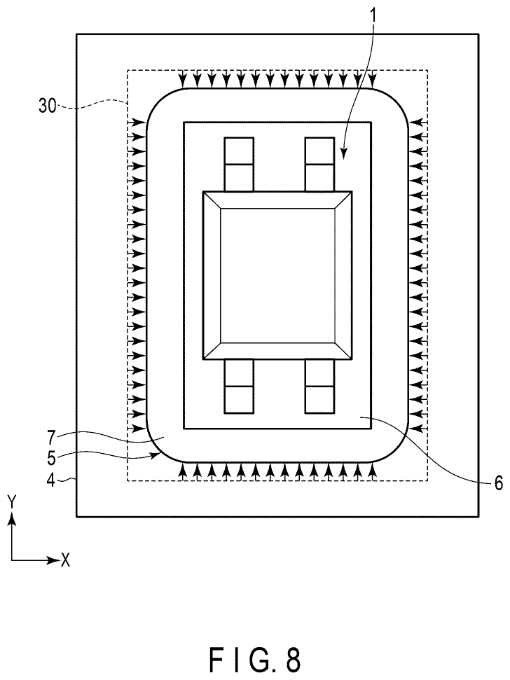

Subsequently, the detection region setting unit 15B sets a detection region 30 in the inspection image (step S102). FIG. 8 is a diagram illustrating an inspection step performed by the inspection apparatus 10. FIG. 8 shows an inspection image obtained by imaging a single semiconductor device 1 to be inspected. The detection region 30 is defined by, for example, a rectangular frame. The detection region 30 is set to have a larger area than the contour of the pocket 5. The contour of the pocket 5 is an outer shape of the side surfaces 7 of the pocket 5 as viewed in a plane. The detection region 30 is set in advance based on a size of the semiconductor device 1 and a size of the pocket 5 formed in a size into which the semiconductor device 1 fits.

Subsequently, the edge detecting unit 15C determines a contour 31 of the pocket 5 based on inspection setting conditions (step S103). Herein, a process of determining a contour will also be referred to as “edge detection”. An “edge” in image processing refers to a position where a brightness sharply changes. FIG. 8 shows how an edge detection process is performed using a plurality of arrows. The edge detecting unit 15C performs an edge detection process in a direction orthogonal to each of four sides of the detection region 30. The edge detection process includes, for example, (1) a process of calculating a brightness gradient (brightness contour) in each of X and Y directions of an image (configured of a plurality of pixels); (2) a process of smoothing the brightness contour (denoising); (3) a process of taking a first derivative of a waveform obtained by the smoothing; and (4) a process of taking a second derivative of the first derivative of the waveform. The inspection setting conditions at step S103 include, in an edge detection process, a detection target color, a detection direction, a number of lines, a line width, a concentration threshold, and a number of continuous pixels neighboring the edge, etc.

If an upper surface of the semiconductor device 1 is irradiated with light, the bottom surface 6 of the pocket 5 and a peripheral part of the pocket 5 will have a higher brightness (will be close to white), and the side surfaces 7 of the pocket 5 will have a lower brightness (will be close to black). The edge detecting unit 15C performs, at each side of the detection region 30, an edge detection along a plurality of pixel lines extending in a direction orthogonal to the side toward the semiconductor device 1. The plurality of pixel lines are schematically shown by the plurality of arrows in FIG. 8. An interval between the plurality of pixel lines set at each side can be arbitrarily set.

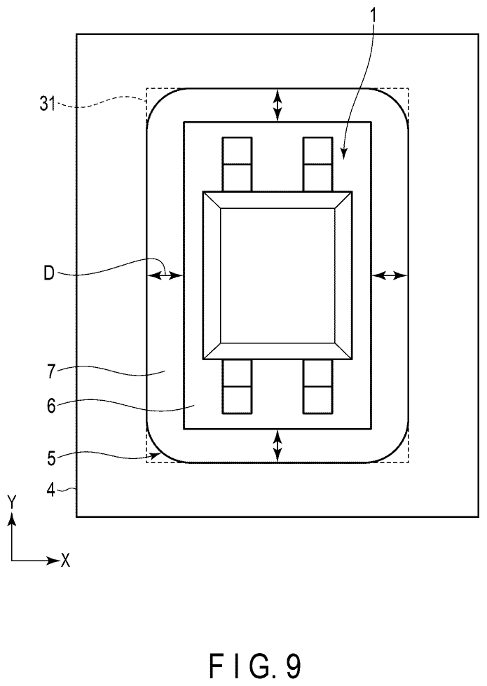

The edge detecting unit 15C detects a point (referred to as a “change point”) where the brightness sharply changes from low to high. Furthermore, the edge detecting unit 15C determines a line connecting a plurality of change points as the contour 31 of the pocket 5. At the time of determining the contour 31, the edge detecting unit 15C also determines continuity of the change points to make each side of the contour 31 a straight line. The edge detecting unit 15C forms the contour 31 based on four intersections of approximate straight lines of the four sides, obtained by performing a linear approximation of the change points under certain conditions. FIG. 9 is a diagram illustrating an inspection step performed by the inspection apparatus 10. In FIG. 9, the edge detecting unit 15C performs an edge detection in an inward direction from the detection region 30, and determines a rectangular contour 31.

Subsequently, the mask generating unit 15D generates a mask 32 using the contour 31 determined at step S103 (step S104). The mask 32 is image data for partially masking the inspection image. Specifically, the mask generating unit 15D sets a definition width D extending inward (toward the semiconductor device 1) from the contour 31, as shown in FIG. 9. The definition width D is set to be a width of each side surface 7 of the pocket 5 containing the semiconductor device 1 as viewed from above. The definition width D is set in advance based on the shape of the carrier tape 4.

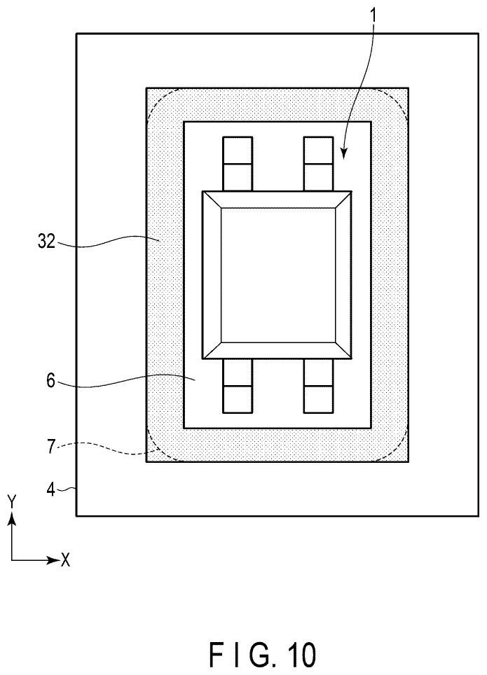

Furthermore, the mask generating unit 15D generates a mask 32 corresponding to a region extending from the contour 31 over the definition width D. FIG. 10 is a diagram illustrating an inspection step performed by the inspection apparatus 10. In FIG. 10, hatching is applied to the mask 32. The mask 32 is generated to have a rectangular frame shape that overlaps the side surfaces 7 of the pocket 5.

If the mask 32 is applied to the above-described configuration shown in FIGS. 5 and 6, the reflections 8 visually recognized at the side surface 7 of the pocket 5 are masked. It is thereby possible to more accurately perform an appearance inspection of the semiconductor device 1.

Subsequently, the inspecting unit 15E performs an appearance inspection of the semiconductor device 1 with the mask 32 set in the inspection image (step S105). Specifically, the inspecting unit 15E measures dimensions of each of the plurality of leads 3, and measures a deviation in length of the leads 3. Also, the inspecting unit 15E measures an interval and/or a pitch between the leads 3. The inspecting unit 15E determines a defective product based on results of the measurement.

### <1-4> Modification

Next, a step of determining a contour 31 of a pocket 5 according to a modification will be described. Edge detection may be performed in an outward direction from the detection region 30, by setting the detection region 30 to be smaller than a contour of the pocket 5.

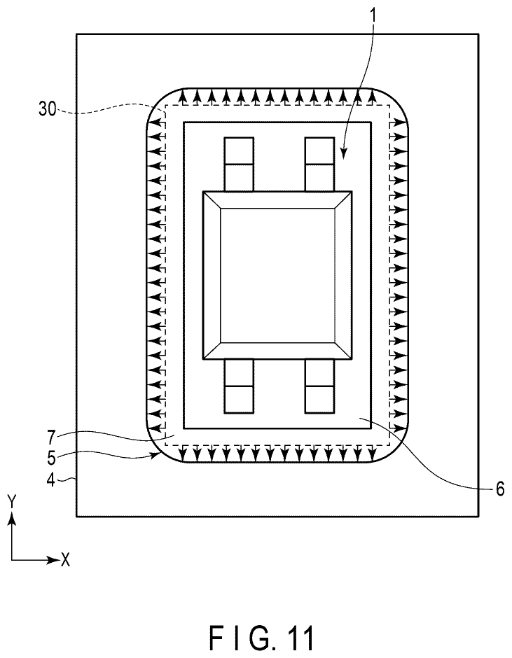

FIG. 11 is a diagram illustrating an inspection step performed by an inspection apparatus 10 according to the modification. A detection region setting unit 15B sets a detection region 30 in an inspection image (step S102). The detection region 30 is set to have a smaller area than the contour of a pocket 5. The edge detecting unit 15C performs an edge detection in an outward direction from the detection region 30, and determines a rectangular contour 31. FIG. 11 shows how an edge detection process is performed using a plurality of arrows. If an upper surface of the semiconductor device 1 is irradiated with light, the bottom surface 6 of the pocket 5 and a peripheral part of the pocket 5 will have a higher brightness (will be close to white), and the side surfaces 7 of the pocket 5 will have a lower brightness (will be close to black). An edge detecting unit 15C detects a change point where the brightness sharply changes from low to high. The subsequent steps are the same as those described in the first embodiment.

According to the first embodiment, the mask 32 can be set on four side surfaces of the pocket 5 of the carrier tape 4 in an inspection image obtained by imaging the semiconductor device 1. It is thereby possible, even if reflections 8 of the leads 3 have occurred on a side surface of the pocket 5, to prevent the reflections 8 from being recognized as part of the leads 3. Moreover, it is possible to perform an appearance inspection of the semiconductor device 1 with the mask 32 set in the inspection image.

Furthermore, it is possible to perform detection of the leads 3 without being affected by a variation in position among semiconductor devices 1 contained in the pockets 5 of the carrier tape 4. As a result, it is possible to more accurately perform an inspection of the semiconductor device 1.

### <2> Second Embodiment

The second embodiment is another embodiment related to the edge detection approach, and is configured to perform an edge detection in an outward direction from an inside of a pocket 5.

### <2-1> Operation

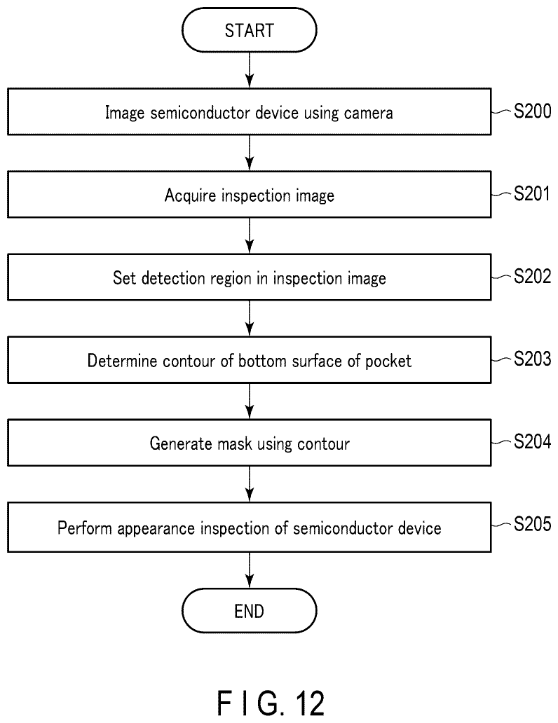

A configuration of the inspection apparatus 10 is the same as that of the first embodiment. FIG. 12 is a flowchart illustrating an inspection operation of the inspection apparatus 10 according to the second embodiment. Operations at steps S200 to S201 in FIG. 12 are the same as those at steps S100 to S101 in FIG. 7.

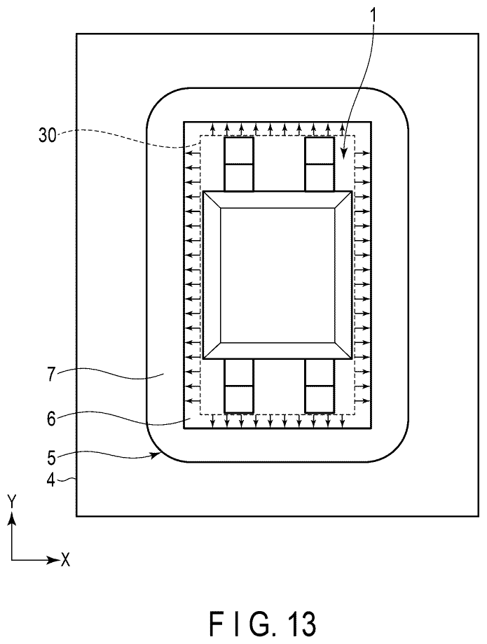

Subsequently, the detection region setting unit 15B sets a detection region 30 in the inspection image (step S202). FIG. 13 is a diagram illustrating an inspection step performed by the inspection apparatus 10. FIG. 13 shows an inspection image obtained by imaging a single semiconductor device 1 to be inspected. The detection region 30 is defined by, for example, a rectangular frame. The detection region 30 is set to have a smaller area than an area of a bottom surface 6 of a pocket 5. The detection region 30 is set in advance based on a size of the semiconductor device 1 and a size of the pocket 5 formed in a size into which the semiconductor device 1 fits.

Subsequently, the edge detecting unit 15C determines a contour 31 of the bottom surface 6 of the pocket 5 based on inspection setting conditions (step S203). FIG. 13 shows how an edge detection process is performed using a plurality of arrows. The edge detecting unit 15C performs an edge detection process in a direction orthogonal to each of four sides of the detection region 30.

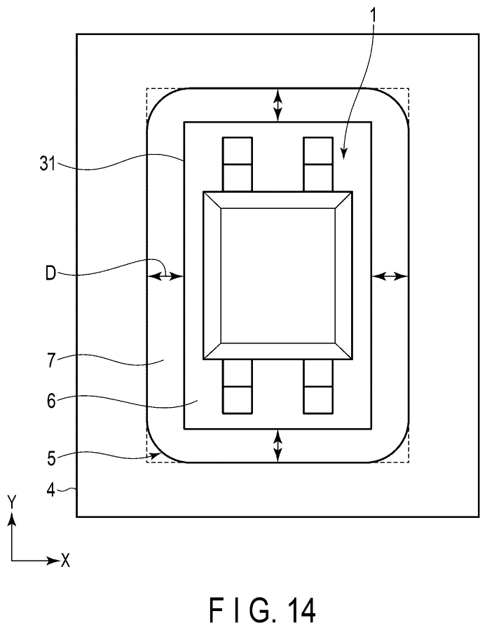

If an upper surface of the semiconductor device 1 is irradiated with light, the bottom surface 6 of the pocket 5 and a peripheral part of the pocket 5 will have a higher brightness (will be close to white), and the side surfaces 7 of the pocket 5 will have a lower brightness (will be close to black). An edge detecting unit 15C detects a change point where the brightness sharply changes from high to low. Furthermore, the edge detecting unit 15C determines a line connecting a plurality of change points as the contour 31 of the bottom surface of the pocket 5. FIG. 14 is a diagram illustrating an inspection step performed by the inspection apparatus 10. In FIG. 14, the edge detecting unit 15C performs an edge detection in an outward direction from the detection region 30, and determines a rectangular contour 31. The contour 31 corresponds to a contour of the bottom surface 6 of the pocket 5.

Subsequently, the mask generating unit 15D generates a mask 32 using the contour 31 determined at step S203 (step S204). Specifically, the mask generating unit 15D sets a definition width D extending outward (toward the contour of the pocket 5) from the contour 31, as shown in FIG. 14. The definition width D is set to be a width of each side surface 7 of the pocket 5 containing the semiconductor device 1 as viewed from above. The definition width D is set in advance based on the shape of the carrier tape 4.

Furthermore, the mask generating unit 15D generates a mask 32 corresponding to a region extending from the contour 31 over the definition width D, similarly to the above-described configuration shown in FIG. 10. The mask 32 is generated to have a rectangular frame shape that overlaps the side surfaces 7 of the pocket 5.

Thereafter, similarly to the first embodiment, the inspecting unit 15E performs an appearance inspection of the semiconductor device 1 with the mask 32 set in the inspection image (step S205).

### <2-2> Modification

Next, a step of determining a contour 31 of a bottom surface 6 of a pocket 5 according to a modification will be described. Edge detection may be performed in an inward direction from the detection region 30, by setting the detection region 30 to be larger than a contour of the bottom surface 6 of the pocket 5.

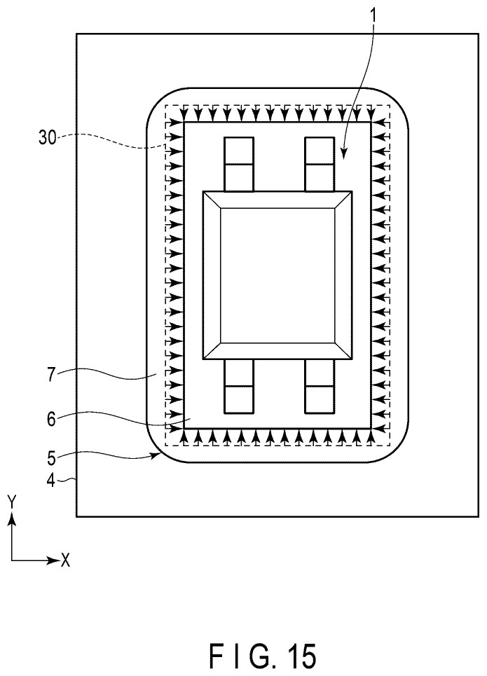

FIG. 15 is a diagram illustrating an inspection step performed by an inspection apparatus 10 according to the modification. A detection region setting unit 15B sets a detection region 30 in an inspection image (step S202). The detection region 30 is set to have a larger area than the contour of the bottom surface 6 of the pocket 5. The edge detecting unit 15C performs an edge detection in an inward direction from the detection region 30, and determines a rectangular contour 31. FIG. 15 shows how an edge detection process is performed, using a plurality of arrows. If an upper surface of the semiconductor device 1 is irradiated with light, the bottom surface 6 of the pocket 5 and a peripheral part of the pocket 5 will have a higher brightness (will be close to white), and the side surfaces 7 of the pocket 5 will have a lower brightness (will be close to black). An edge detecting unit 15C detects a change point where the brightness sharply changes from low to high. The subsequent steps are the same as those described in the second embodiment.

According to the second embodiment, in the edge detection process, it is possible to determine the contour 31 of the bottom surface 6 of the pocket 5. Moreover, it is possible to generate a mask 32 that masks four side surfaces of the pocket 5 using the determined contour 31. The other effects are similar to those of the first embodiment.

### <3> Modification

In the above-described embodiments, an example of inspecting a semiconductor device 1 including a plurality of leads 3 has been described. However, the configuration is not limited thereto, and application may be made to a semiconductor device 1 with another configuration. For example, application may be made to a semiconductor device 1 not including a lead.

The processes according to the above-described embodiments may be stored as programs (software means) executable by a computer (a calculating machine) in a storage medium such as a magnetic disk, an optical disk, and a semiconductor memory, or may be distributed through transmission via a communication medium. Such a communication medium includes a storage medium provided in a computer, or a storage medium provided in equipment connected via a network. Upon reading the programs stored in the storage medium for controlling the operations, the computer executes the above-described processes.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inspection apparatus for inspecting a semiconductor device, the semiconductor device being contained in a rectangular pocket included in carrier tape, the inspection apparatus comprising:
an acquiring unit configured to acquire an inspection image obtained by imaging the semiconductor device with an imaging device;
a detecting unit configured to determine a contour of the pocket by performing edge detection on the inspection image;
a generating unit configured to generate a mask corresponding to a region extending inward from the determined contour by a predetermined width; and
an inspecting unit configured to inspect the semiconductor device with the mask set in the inspection image.

2. The inspection apparatus according to claim 1, further comprising:
a setting unit configured to set, in the inspection image, a rectangular detection region having an area larger than that of the contour of the pocket, wherein
the detecting unit is configured to determine the contour of the pocket by performing the edge detection in a direction from the rectangular detection region toward the inside of the pocket.

3. The inspection apparatus according to claim 2, wherein
the detecting unit performs the edge detection in a direction orthogonal to each of four sides of the detection region.

4. The inspection apparatus according to claim 1, further comprising:
a setting unit configured to set, in the inspection image, a rectangular detection region having an area smaller than that of the contour of the pocket, wherein
the detecting unit is configured to determine the contour of the pocket by performing the edge detection in a direction from the rectangular detection region toward the outside of the pocket.

5. The inspection apparatus according to claim 4, wherein
the detecting unit performs the edge detection in a direction orthogonal to each of four sides of the detection region.

6. The inspection apparatus according to claim 1, wherein
the semiconductor device includes a resin part and a plurality of leads connected to the resin part, and
the inspecting unit is configured to inspect dimensions of the leads.

7. The inspection apparatus according to claim 1, wherein
the predetermined width is set based on a width of a side surface of the pocket as viewed in a plane.

8. An inspection apparatus for inspecting a semiconductor device, the semiconductor device being contained in a rectangular pocket included in carrier tape, the inspection apparatus comprising:
an acquiring unit configured to acquire an inspection image obtained by imaging the semiconductor device with an imaging device;
a detecting unit configured to perform edge detection on the inspection image to determine a contour of a bottom surface of the pocket;
a generating unit configured to generate a mask corresponding to a region extending outward from the determined contour by a predetermined width; and
an inspecting unit configured to inspect the semiconductor device with the mask set in the inspection image.

9. The inspection apparatus according to claim 8, further comprising:
a setting unit configured to set, in the inspection image, a rectangular detection region having an area smaller than that of the bottom surface of the pocket, wherein
the detecting unit is configured to determine the contour of the bottom surface of the pocket by performing the edge detection in a direction from the rectangular detection region toward the outside of the pocket.

10. The inspection apparatus according to claim 9, wherein
the detecting unit performs the edge detection in a direction orthogonal to each of four sides of the detection region.

11. The inspection apparatus according to claim 8, further comprising:
a setting unit configured to set, in the inspection image, a rectangular detection region having an area larger than that of the bottom surface of the pocket, wherein
the detecting unit is configured to determine the contour of the bottom surface of the pocket by performing the edge detection in a direction from the rectangular detection region toward the inside of the pocket.

12. The inspection apparatus according to claim 11, wherein
the detecting unit performs the edge detection in a direction orthogonal to each of four sides of the detection region.

13. The inspection apparatus according to claim 8, wherein
the semiconductor device includes a resin part and a plurality of leads connected to the resin part, and
the inspecting unit is configured to inspect dimensions of the leads.

14. The inspection apparatus according to claim 8, wherein
the predetermined width is set based on a width of a side surface of the pocket as viewed in a plane.

15. A method for inspecting a semiconductor device, the semiconductor device being contained in a rectangular pocket included in carrier tape, the method comprising:
acquiring an inspection image obtained by imaging the semiconductor device with an imaging device;
generating a mask corresponding to a region between a contour of the pocket and a contour of a bottom surface of the pocket; and
inspecting the semiconductor device with the mask set in the inspection image.

16. The method according to claim 15, further comprising:
determining the contour of the pocket by performing edge detection on the inspection image, wherein
generating the mask corresponding to the region includes extending the mask inward from the determined contour of the pocket by a predetermined width.

17. The method according to claim 16, further comprising:
setting, in the inspection image, a rectangular detection region having an area larger than that of the contour of the pocket, wherein
determining the contour of the pocket includes performing edge detection in a direction from the rectangular detection region toward the inside of the pocket.

18. The method according to claim 16, further comprising:
setting, in the inspection image, a rectangular detection region having an area smaller than that of the contour of the pocket, wherein
determining the contour of the pocket includes performing edge detection in a direction from the rectangular detection region toward the outside of the pocket.

19. The method according to claim 15, further comprising:
determining the contour of the bottom surface of the pocket by performing edge detection on the inspection image, wherein
generating the mask corresponding to the region includes extending the mask outward from the determined contour of the bottom surface of the pocket by a predetermined width.

20. The method according to claim 19, further comprising:
setting, in the inspection image, a rectangular detection region having an area smaller than that of the bottom surface of the pocket, wherein
determining the contour of the bottom surface of the pocket includes performing edge detection in a direction from the rectangular detection region toward the outside of the pocket.

21. The method according to claim 19, further comprising:
setting, in the inspection image, a rectangular detection region having an area larger than that of the bottom surface of the pocket, wherein
determining the contour of the bottom surface of the pocket includes performing edge detection in a direction from the rectangular detection region toward the inside of the pocket.
